(19) United States
(12) Patent Application Publication
(10) Pub. No.: US 2022/0222585 A1
(43) Pub. Date: Jul. 14, 2022

(54) LEARNING APPARATUS, LEARNING METHOD AND PROGRAM

(71) Applicant: NIPPON TELEGRAPH AND TELEPHONE CORPORATION, Tokyo (JP)

(72) Inventor: Tomoharu IWATA, Tokyo (JP)

(73) Assignee: NIPPON TELEGRAPH AND TELEPHONE CORPORATION, Tokyo (JP)

(21) Appl. No.: 17/761,145

(22) PCT Filed: Sep. 18, 2019
(86) PCT No.: PCT/JP2019/036651

§ 371 Date: Mar. 16, 2022

(51) Int. Cl. G06N 20/00; G06F 17/11

(52) U.S. Cl. CPC G06N 20/00; G06F 17/11

(57) ABSTRACT

A training apparatus includes a calculation unit that takes a set of first data elements that are labeled and a set of second data elements that are unlabeled as inputs and calculates a value of a predetermined objective function that represents an evaluation index when a false positive rate is in a predetermined range and a derivative of the objective function with respect to a parameter, and an updating unit that updates the parameter such that the value of the objective function is maximized or minimized using the value of the objective function and the derivative calculated by the calculation unit.

### TECHNICAL FIELD

The present invention relates to a training apparatus, a training method, and a program.

### BACKGROUND ART

A task called binary classification is known. Binary classification is a task of, when a data element is given, classifying the data element as either a positive example or a negative example.

A partial area under the ROC curve (pAUC) is known as an evaluation index for evaluating the classification performance of binary classification. By maximizing the pAUC, it is possible to improve the classification performance while keeping the false positive rate low.

A method of maximizing a pAUC has been proposed in the related art (see, for example, NPL 1). A method of maximizing an AUC using a semi-supervised learning method has also been proposed in the related art (see, for example, NPL 2).

### CITATION LIST

### Non Patent Literature

NPL 1: Naonori Ueda, Akinori Fujino, “Partial AUC Maximization via Nonlinear Scoring Functions,” arXiv: 1806.04838, 2018
NPL 2: Akinori Fujino, Naonori Ueda, “A Semi-Supervised AUC Optimization Method with Generative Models,” ICDM, 2016

### SUMMARY OF THE INVENTION

### Technical Problem

However, in the method proposed in NPL 1 above, for example, it is necessary to prepare a large amount of labeled data. On the other hand, in the method proposed in NPL 2 above, for example, unlabeled data can also be utilized by the semi-supervised training method, but it is not possible to improve classification performance focused on a specific false positive rate because the entire AUC is maximized.

An embodiment of the present invention has been made in view of the above points and it is an object thereof to improve the classification performance at specific false positive rates.

### Means for Solving the Problem

To achieve the object, a training apparatus according to an embodiment of the present invention includes a calculation unit configured to take a set of first data elements that are labeled and a set of second data elements that are unlabeled as inputs and calculate a value of a predetermined objective function that represents an evaluation index when a false positive rate is in a predetermined range and a derivative of the objective function with respect to a parameter and an updating unit configured to update the parameter such that the value of the objective function is maximized or minimized using the value of the objective function and the derivative calculated by the calculation unit.

### Effects of the Invention

It is possible to improve the classification performance at specific false positive rates.

### BRIEF DESCRIPTION OF DRAWINGS

FIG. 1 is a diagram illustrating an example of a functional configuration of a training apparatus and a classification apparatus according to an embodiment of the present invention.

FIG. 2 is a flowchart showing an example of a training process according to the embodiment of the present invention.

FIG. 3 is a diagram illustrating an example of a hardware configuration of a training apparatus and a classification apparatus according to the embodiment of the present invention.

### DESCRIPTION OF EMBODIMENTS

Hereinafter an embodiment of the present invention will be described. In the embodiment of the present invention, a training apparatus 10 that can improve the classification performance at specific false positive rates when labeled data and unlabeled data elements are given will be described. A classification apparatus 20 that classifies data using a classifier trained by the training apparatus 10 will also be described. A label is information indicating whether a data element labeled with the label is a positive example or a negative example (that is, information indicating a correct answer).

Theoretical Configuration First, a theoretical configuration of the embodiment of the present invention will be described. It is assumed that a set P of data elements labeled with a label indicating a positive example (hereinafter also referred to as “positive-example data elements”), a set N of data elements labeled with a label indicating a negative example (hereinafter also referred to as “negative-example data elements”), and a set U of unlabeled data elements are given as input data, the sets being represented by the following equations.

[symbol]

={xₘ^{P}}ₘ₌₁^{M}^{_{P}} [Math. 1]

[symbol]

={xₘ^{N}}ₘ₌₁^{M}^{_{N}} [Math. 2]

[symbol]

={xₘ^{U}}ₘ₌₁^{M}^{_{Y}} [Math. 3]

Here, each data element is, for example, a D-dimensional feature vector. However, each data element is not limited to a vector and may be data of any format (for example, series data, image data, or set data).

At this time, in the embodiment of the present invention, the classifier is trained such that the classification performance becomes higher when the false positive rate is in a range of a to β. α and β are arbitrary values given in advance (where 0≤α<β≤1).

In the embodiment of the present invention, the classifier to be trained is represented by s(x). Any classifier can be used as the classifier s(x). For example, a neural network can be used as the classifier s(x). It is also assumed that the classifier s(x) outputs a score on the classification of the data element x as a positive example. That is, it is assumed that the higher the score of a data element x, the more easily the data element x is classified as a positive example.

Here, a pAUC is an evaluation index indicating the classification performance when the false positive rate is in the range of α to β. In the embodiment of the present invention, the classifier s(x) is trained using a pAUC calculated using positive-example data elements and negative-example data elements, a pAUC calculated using positive-example data elements and unlabeled data elements, and a pAUC calculated using negative-example data elements and unlabeled data elements. A pAUC is an example of an evaluation index and other evaluation indices indicating the classification performance at specific false positive rates may be used instead of the pAUC.

The pAUC calculated using positive-example data elements and negative-example data elements becomes higher when the scores of positive-example data elements are higher than the scores of negative-example data elements which are in the range of false positive rates from a to β. The pAUC calculated using positive-example data elements and negative-example data elements can be calculated, for example, by the following equation (1).

$$\begin{matrix} [ Math . 4 ] & \\ ( α , β ) = \frac{1}{( β - α ) {M}_{P} {M}_{N}} {\sum }_{{x}_{m}^{P} ∈ P} [ ( {j}_{α} - α {M}_{N} ) I ( s ( {x}_{m}^{P} ) > s ( {x}_{( {j}_{α} )}^{N} ) ) + {\sum }_{j = {j}_{α} + 1}^{{j}_{β}} I ( s ( {x}_{m}^{P} ) > s ( {x}_{( j )}^{N} ) ) + ( β {M}_{N} - {j}_{β} ) I ( s ( {x}_{m}^{P} ) > s ( {x}_{( {j}_{β} + 1 )}^{N} ) ) ] & ( 1 )\end{matrix}$$

where I(⋅) is an indicator function,

[symbol]

_{α}=┌αM_{N}┐,j_{β}=┌βM_{N}┐ [Math. 5]

[symbol]

[Math. 6]

indicates a j-th negative-example data element when the negative-example data elements are arranged in descending order of scores.

The pAUC calculated using positive-example data elements and unlabeled data elements becomes higher when the scores of positive-example data elements are higher than the scores of unlabeled data elements which are in the range of false positive rates from α to β among unlabeled data elements estimated as negative examples. The pAUC calculated using positive-example data elements and unlabeled data elements can be calculated, for example, by the following equation (2).

$$\begin{matrix} [ Math . 7 ] & \\ {PU}_{} ( {θ}_{P} + {αθ}_{N} , {θ}_{P} + {βθ}_{N} ) = \frac{1}{( β - α ) {θ}_{N} {M}_{P} {M}_{U}} {\sum }_{{x}_{m}^{P} ∈ P} [ ( {k}_{\overline{α}} - \overline{α} {M}_{U} ) I ( s ( {x}_{m}^{P} ) > s ( {x}_{( {k}_{\overline{α}} )}^{U} ) ) + {\sum }_{k = {k}_{\overline{α}} + 1}^{{k}_{\overline{β}}} I ( s ( {x}_{m}^{P} ) > s ( {x}_{( k )}^{U} ) ) + ( \overline{β} {M}_{U} - {k}_{\overline{β}} ) I ( s ( {x}_{m}^{P} ) > s ( {x}_{( {k}_{\overline{β}} + 1 )}^{U} ) ) ] \\ \\ where & ( 2 ) \\ [ Math . 8 ] & \\ \overline{α} = {θ}_{P} + {αθ}_{N} , \overline{β} = {θ}_{P} + {βθ}_{N} , {k}_{\overline{α}} = ⌈ \overline{α} {M}_{U} ⌉ , {k}_{\overline{β}} = ⌊ \overline{β} {M}_{U} ⌋ & ( 3 )\end{matrix}$$

θ_{N} is the proportion of negative examples in the unlabeled data elements, and

x₍ₖ₎^{U} [Math. 9]

indicates a k-th unlabeled data element when the unlabeled data elements are arranged in descending order of scores.

The pAUC calculated using negative-example data elements and unlabeled data elements becomes higher when the scores of unlabeled data elements estimated as positive examples are higher than the scores of negative-example data elements which are in the range of false positive rates from α to β. The pAUC calculated using negative-example data elements and unlabeled data elements can be calculated, for example, by the following equation (3).

$$\begin{matrix} [ Math . 10 ] & \\ {NU}_{} ( ( 0 , {θ}_{P} ) , ( α , β ) ) - \frac{1}{( β - α ) {θ}_{P} {M}_{U} {M}_{N}} [ ( {j}_{α} - α {M}_{N} ) {\sum }_{k = 0}^{{k}_{{θ}_{P}}} I ( s ( {x}_{( k )}^{U} ) > s ( {x}_{( {j}_{α} )}^{N} ) ) + {\sum }_{k = 0}^{{k}_{{θ}_{P}}} {\sum }_{j = {j}_{α} + 1}^{{j}_{β}} I ( s ( {x}_{( k )}^{U} ) > s ( {x}_{( j )}^{N} ) ) + ( β {M}_{N} - {j}_{β} ) {\sum }_{k = 0}^{{k}_{{θ}_{P}}} I ( s ( {x}_{( k )}^{U} ) > s ( {x}_{( {j}_{β} + 1 )}^{N} ) ) + ( {θ}_{P} {M}_{U} - {k}_{{θ}_{P}} ) {\sum }_{j = {j}_{α} + 1}^{{j}_{β}} I ( s ( {x}_{( {k}_{{θ}_{P}} + 1 )}^{U} ) > s ( {x}_{( j )}^{N} ) ) + ( {θ}_{P} {M}_{U} - {k}_{{θ}_{P}} ) ( {β}_{{M}_{N}} - {j}_{β} ) I ( s ( {x}_{( {k}_{{θ}_{P}} + 1 )}^{U} ) > s ( {x}_{( {j}_{β} + 1 )}^{N} ) ) ] & ( 3 )\end{matrix}$$

where θ_{P} is the proportion of positive examples in the unlabeled data elements and

k_{θ}_{_{P}}=└θ_{P}M_{U}┘ [Math. 11]

Then, the classifier s(x) is trained by updating parameters of the classifier s(x) such that a weighted sum of the pAUC calculated using positive-example data elements and negative-example data elements, the pAUC calculated using positive-example data elements and unlabeled data elements, and the pAUC calculated using negative-example data elements and unlabeled data elements is maximized. For example, using L shown in the following equation (4) as an objective function, the parameters of the classifier s(x) can be updated such that the value of the objective function L is maximized using a known optimization method such as a stochastic gradient descent method.

[Math. 12]

L=λ₁ [symbol] (α,β)+λ₂ [symbol] _{PU}(θ_{P}+αθ_{N},θ_{P}+βθ_{N})+λ₃ [symbol] _{NU}((0,θ_{P}),(α,β)) (4)

where the first term of equation (4) is the pAUC calculated using positive-example data elements and negative-example data elements, the second term is the pAUC calculated using positive-example data elements and unlabeled data elements, and the third term is the pAUC calculated using negative-example data elements and unlabeled data elements. In addition,

\tilde{⋅} [Math. 13]

indicates a smooth function (i.e., a differentiable function) that approximates a step function. For example, a sigmoid function can be used as a smooth approximation of a step function.

λ₁, λ₂, and λ₃ are non-negative hyperparameters. For these hyperparameters, for example, those that maximize development data in the data set used for training the classifier s(x) can be selected.

A regularization term, an unsupervised training term, or the like may further be added to the objective function L shown in the above equation (4).

By using the classifier s(x) trained as described above, the embodiment of the present invention can improve the classification performance of data elements x at specific false positive rates. Although the embodiment of the present invention will be described with respect to the case where a set of positive-example data elements, a set of negative-example data elements, and a set of unlabeled data elements are given, the same applies, for example, to the case where a set of positive-example data elements and a set of unlabeled data elements are given and the case where a set of negative-example data elements and a set of unlabeled data elements are given. The objective function L shown in the above equation (4) becomes only the second term in the case where a set of positive-example data elements and a set of unlabeled data elements are given and becomes only the third term in the case where a set of negative-example data elements and a set of unlabeled data elements are given.

The embodiment of the present invention can also be similarly applied to a multi-class classification problem by adopting a method that extends pAUCs to those for multiple classes.

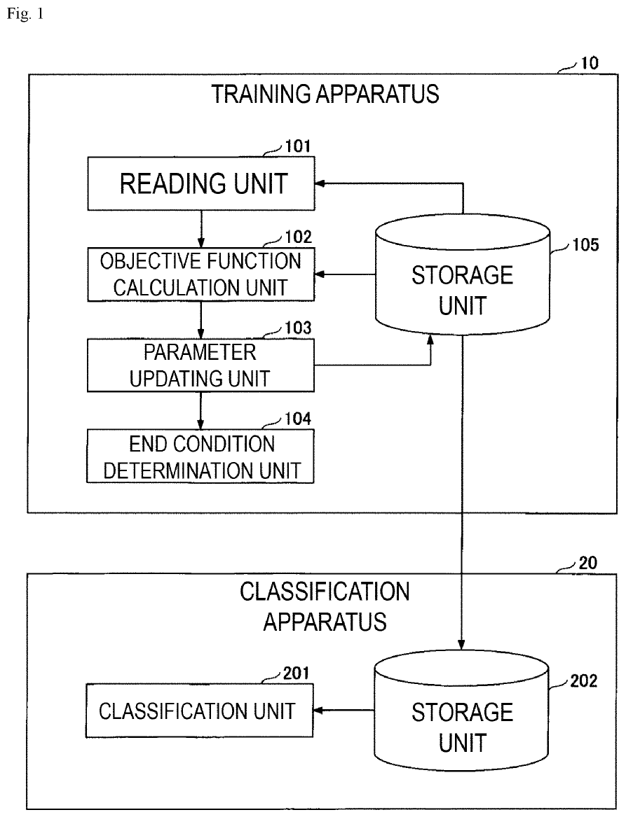

Functional Configuration Hereinafter, a functional configuration of the training apparatus 10 and the classification apparatus 20 according to the embodiment of the present invention will be described with reference to FIG. 1. FIG. 1 is a diagram illustrating an example of the functional configuration of the training apparatus 10 and the classification apparatus 20 according to the embodiment of the present invention.

As illustrated in FIG. 1, the training apparatus 10 according to the embodiment of the present invention includes a reading unit 101, an objective function calculation unit 102, a parameter updating unit 103, an end condition determination unit 104, and a storage unit 105.

The storage unit 105 stores various data. The various data stored in the storage unit 105 include, for example, sets of data elements used for training the classifier s(x) (that is, for example, a set of positive-example data elements, a set of negative-example data elements, and a set of unlabeled data elements), and parameters of an objective function (for example, parameters of the objective function L shown in the above equation (4)).

The reading unit 101 reads a set of positive-example data elements, a set of negative-example data elements, and a set of unlabeled data elements stored in the storage unit 105. The reading unit 101 may read a set of positive-example data elements, a set of negative-example data elements, and a set of unlabeled data elements, for example, by acquiring (downloading) them from a predetermined server device or the like.

The objective function calculation unit 102 calculates a value of a predetermined objective function (for example, the objective function L shown in the above equation (4)) and its derivative with respect to the parameters (that is, the parameters of the classifier s(x)) by using the set of positive-example data elements, the set of negative-example data elements, and the set of unlabeled data elements read by the reading unit 101.

The parameter updating unit 103 updates the parameters such that the value of the objective function increases (or decreases) using the value of the objective function calculated by the objective function calculation unit 102 and the derivative.

The end condition determination unit 104 determines whether or not a predetermined end condition is satisfied. The calculation of the objective function value and the derivative by the objective function calculation unit 102 and the parameter update by the parameter updating unit 103 are repeatedly executed until the end condition determination unit 104 determines that the end condition is satisfied. The parameters of the classifier s(x) are trained in this manner. The trained parameters of the classifier s(x) are transmitted to the classification apparatus 20, for example, via an arbitrary communication network.

Examples of the end condition include that the number of repetitions exceeds a predetermined number, that the amount of change in the objective function value before and after a repetition is equal to or less than a predetermined first threshold value, and that the amount of change in the parameters before and after an update is equal to or less than a predetermined second threshold value.

The classification apparatus 20 according to the embodiment of the present invention further includes a classification unit 201 and a storage unit 202 as illustrated in FIG. 1.

The storage unit 202 stores various data. The various data stored in the storage unit 202 include, for example, the parameters of the classifier s(x) trained by the training apparatus 10 and the data element x to be classified by the classifier s(x).

The classification unit 201 classifies each data element x stored in the storage unit 202 using the trained classifier s(x). That is, for example, the classification unit 201 calculates a score of a data element x using the trained classifier s(x) and then classifies the data element x as either a positive example or a negative example based on the score. For example, the classification unit 201 may classify the data element x as a positive example when the score is equal to or higher than a predetermined third threshold value and as a negative example when the score is not. Thus, the data element x can be classified with high accuracy at specific false positive rates.

The functional configuration of the training apparatus 10 and the classification apparatus 20 illustrated in FIG. 1 is an example and may be another configuration. For example, the training apparatus 10 and the classification apparatus 20 may be realized integrally.

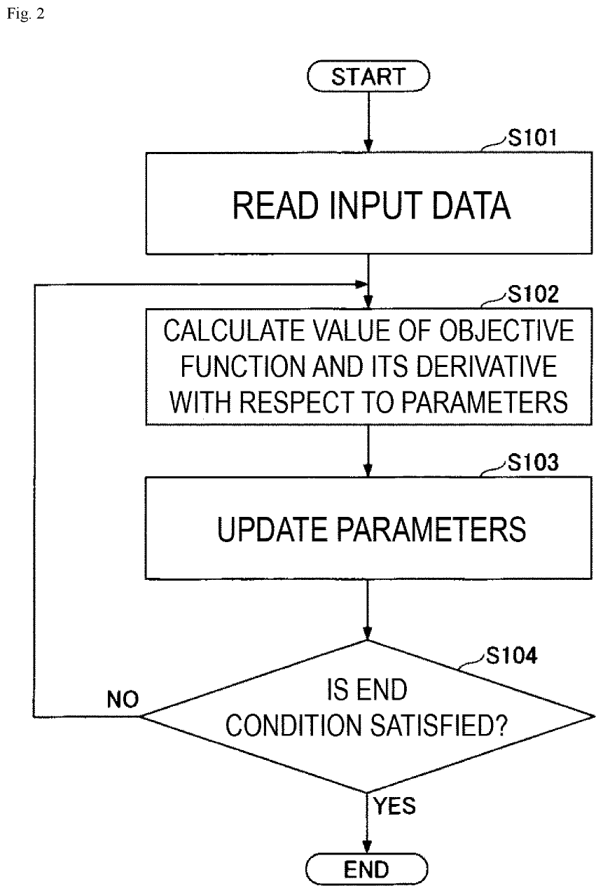

Flow of Training Process Hereinafter, a training process in which the training apparatus 10 trains the classifier s(x) will be described with reference to FIG. 2. FIG. 2 is a flowchart showing an example of the training process according to the embodiment of the present invention.

First, the reading unit 101 reads a set of positive-example data elements, a set of negative-example data elements, and a set of unlabeled data elements stored in the storage unit 105 (step S101).

Next, the objective function calculation unit 102 calculates a value of a predetermined objective function (for example, the objective function L shown in the above equation (4)) and its derivative with respect to the parameters by using the set of positive-example data elements, the set of negative-example data elements, and the set of unlabeled data elements read in step S101 above (step S102).

Next, the parameter updating unit 103 updates the parameters such that the value of the objective function increases (or decreases) using the value of the objective function and the derivative calculated in step S102 above (step S103).

Next, the end condition determination unit 104 determines whether or not a predetermined end condition is satisfied (step S104). If it is not determined that the end condition is satisfied, the process returns to step S102. On the other hand, if it is determined that the end condition is satisfied, the training process is terminated.

The parameters of the classifier s(x) are updated and the classifier s(x) is trained by repeating the above steps S102 to S103 as described above. Thus, the classification apparatus 20 can classify the data element x with high accuracy at specific false positive rates using the trained classifier s(x).

Evaluation Hereinafter, evaluation of the embodiment of the present invention will be described. In order to evaluate the embodiment of the present invention, evaluation was performed using nine data sets with the pAUC as an evaluation index. A higher value of the pAUC indicates higher classification performance.

The following are comparative methods with the method of the embodiment of the present invention that will be referred to as “Ours.”

CE: Conventional classification method that minimizes cross entropy loss

MA: Conventional classification method that maximizes AUC

MPA: Conventional classification method that maximizes pAUC

SS: Conventional semi-supervised classification method that maximizes AUC

SSR: Conventional semi-supervised classification method that maximizes AUC using label proportion

pSS: Conventional semi-supervised classification method that maximizes pAUC

pSSR: Conventional semi-supervised classification method that maximizes pAUC using label proportion

Here, the pAUCs of Ours and the comparative methods when α=0 and β=0.1 are shown in Table 1 below. Average represents the average of pAUCs calculated for the data element sets.

TABLE 1

| | CE | MA | MPA | SS | SSR | pSS | pSSR | Ours |
|---|---|---|---|---|---|---|---|---|
| Annthyroid | 0.227 | 0.236 | 0.384 | 0.399 | 0.422 | 0.258 | 0.457 | 0.388 |
| Cardio- | 0.464 | 0.473 | 0.493 | 0.420 | 0.450 | 0.467 | 0.393 | 0.527 |
| tocography | | | | | | | | |
| InternetAds | 0.540 | 0.570 | 0.565 | 0.496 | 0.464 | 0.527 | 0.446 | 0.580 |
| KDDCup99 | 0.880 | 0.868 | 0.874 | 0.837 | 0.832 | 0.867 | 0.802 | 0.884 |
| PageBlocks | 0.528 | 0.518 | 0.593 | 0.599 | 0.599 | 0.553 | 0.568 | 0.598 |
| Pima | 0.057 | 0.118 | 0.188 | 0.179 | 0.130 | 0.127 | 0.118 | 0.206 |
| SpamBase | 0.408 | 0.438 | 0.461 | 0.422 | 0.393 | 0.435 | 0.416 | 0.484 |
| Waveform | 0.270 | 0.253 | 0.288 | 0.268 | 0.281 | 0.305 | 0.226 | 0.306 |
| Wilt | 0.100 | 0.195 | 0.594 | 0.648 | 0.403 | 0.260 | 0.703 | 0.681 |
| Average | 0.386 | 0.408 | 0.493 | 0.474 | 0.442 | 0.422 | 0.459 | 0.517 |

Table 2 below shows the pAUCs of Ours and the comparative methods when α=0 and β=0.3.

TABLE 2

| | CE | MA | MPA | SS | SSR | pSS | pSSR | Ours |
|---|---|---|---|---|---|---|---|---|
| Annthyroid | 0.442 | 0.436 | 0.517 | 0.516 | 0.445 | 0.428 | 0.506 | 0.503 |
| Cardio- | 0.680 | 0.705 | 0.698 | 0.661 | 0.665 | 0.686 | 0.637 | 0.725 |
| tocography | | | | | | | | |
| InternetAds | 0.664 | 0.697 | 0.695 | 0.629 | 0.631 | 0.621 | 0.590 | 0.672 |
| KDDCup99 | 0.949 | 0.941 | 0.944 | 0.929 | 0.914 | 0.943 | 0.904 | 0.961 |
| PageBlocks | 0.679 | 0.677 | 0.717 | 0.746 | 0.744 | 0.729 | 0.753 | 0.727 |
| Pima | 0.255 | 0.324 | 0.387 | 0.384 | 0.364 | 0.327 | 0.346 | 0.355 |
| SpamBase | 0.698 | 0.690 | 0.691 | 0.663 | 0.627 | 0.662 | 0.617 | 0.687 |
| Waveform | 0.624 | 0.619 | 0.598 | 0.571 | 0.548 | 0.595 | 0.500 | 0.609 |
| Wilt | 0.326 | 0.440 | 0.813 | 0.803 | 0.687 | 0.539 | 0.790 | 0.845 |
| Average | 0.591 | 0.614 | 0.673 | 0.656 | 0.625 | 0.614 | 0.627 | 0.676 |

Table 3 below shows the pAUCs of Ours and the comparative methods when α=0.1 and β=0.2.

TABLE 3

| | CE | MA | MPA | SS | SSR | pSS | pSSR | Ours |
|---|---|---|---|---|---|---|---|---|
| Annthyroid | 0.480 | 0.469 | 0.526 | 0.537 | 0.459 | 0.454 | 0.456 | 0.510 |
| Cardio- | 0.729 | 0.750 | 0.752 | 0.697 | 0.685 | 0.746 | 0.601 | 0.761 |
| tocography | | | | | | | | |
| InternetAds | 0.697 | 0.734 | 0.729 | 0.611 | 0.637 | 0.663 | 0.558 | 0.724 |
| KDDCup99 | 0.982 | 0.977 | 0.982 | 0.967 | 0.956 | 0.973 | 0.963 | 0.988 |
| PageBlocks | 0.713 | 0.718 | 0.751 | 0.784 | 0.782 | 0.776 | 0.708 | 0.763 |
| Pima | 0.294 | 0.353 | 0.388 | 0.425 | 0.404 | 0.376 | 0.337 | 0.447 |
| SpamBase | 0.764 | 0.760 | 0.775 | 0.713 | 0.688 | 0.727 | 0.623 | 0.768 |
| Waveform | 0.708 | 0.695 | 0.626 | 0.536 | 0.594 | 0.683 | 0.522 | 0.654 |
| Wilt | 0.341 | 0.462 | 0.700 | 0.854 | 0.714 | 0.567 | 0.858 | 0.865 |
| Average | 0.634 | 0.658 | 0.692 | 0.681 | 0.658 | 0.663 | 0.625 | 0.720 |

As shown in Tables 1 to 3 above, it can be seen that the method of the embodiment of the present invention (Ours) achieves high classification performance in a larger number of data sets than the other comparative methods.

Hardware Configuration

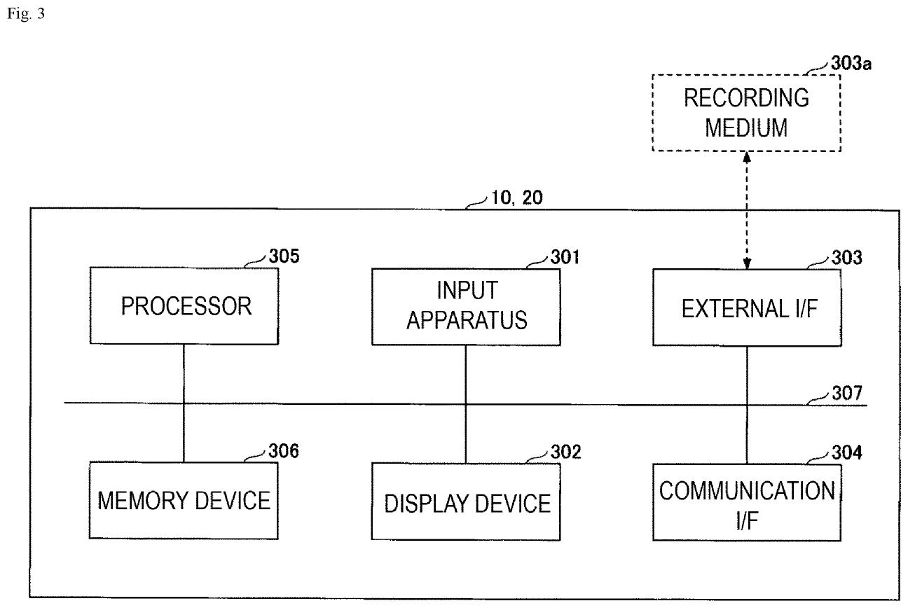

Finally, a hardware configuration of the training apparatus 10 and the classification apparatus 20 according to the embodiment of the present invention will be described with reference to FIG. 3. FIG. 3 is a diagram illustrating an example of the hardware configuration of the training apparatus 10 and the classification apparatus 20 according to the embodiment of the present invention. The hardware configuration of the training apparatus 10 will be mainly described below because the training apparatus 10 and the classification apparatus 20 are realized by the same hardware configuration.

As illustrated in FIG. 3, the training apparatus 10 according to the embodiment of the present invention includes an input device 301, a display device 302, an external I/F 303, a communication I/F 304, a processor 305, and a memory device 306. These hardware components are communicatively connected via a bus 307.

The input device 301 is, for example, a keyboard, a mouse, or a touch panel and is used for a user to input various operations. The display device 302 is, for example, a display and displays a processing result or the like of the training apparatus 10. The training apparatus 10 may not include at least one of the input device 301 and the display device 302.

The external I/F 303 is an interface with an external device. The external device includes a recording medium 303a and the like. The training apparatus 10 can read from or write to the recording medium 303a via the external I/F 303. The recording medium 303a may record, for example, one or more programs that implement each functional unit of the training apparatus 10 (for example, the reading unit 101, the objective function calculation unit 102, the parameter updating unit 103, and the end condition determination unit 104).

Examples of the recording medium 303a include a compact disc (CD), a digital versatile disc (DVD), a secure digital (SD) memory card, and a universal serial bus (USB) memory card.

The communication I/F 304 is an interface for connecting the training apparatus 10 to the communication network. One or more programs that implement each functional unit of the training apparatus 10 may be acquired (downloaded) from a predetermined server device or the like via the communication I/F 304.

The processor 305 is, for example, a central processing unit (CPU) or a graphics processing unit (GPU) and is an arithmetic unit that reads a program or data from the memory device 306 or the like and executes processing. Each functional unit of the training apparatus 10 is implemented by a process of causing the processor 305 to execute one or more programs stored in the memory device 306 or the like. Similarly, each functional unit of the classification apparatus 20 (for example, the classification unit 201) is implemented by a process of causing the processor 305 to execute one or more programs stored in the memory device 306 or the like.

The memory device 306 is, for example, a hard disk drive (HDD), a solid state drive (SSD), a random access memory (RAM), a read only memory (ROM), or a flash memory and is a storage device for storing programs and data. The storage unit 105 included in the training apparatus 10 is implemented by the memory device 306 or the like. Similarly, the storage unit 202 included in the classification apparatus 20 is implemented by the memory device 306 or the like.

The training apparatus 10 and the classification apparatus 20 according to the embodiment of the present invention can realize the various processing described above by having the hardware configuration illustrated in FIG. 3. The hardware configuration illustrated in FIG. 3 is an example and the training apparatus 10 may have another hardware configuration. For example, the training apparatus 10 and the classification apparatus 20 may have a plurality of processors 305 or may have a plurality of memory devices 306.

The present invention is not limited to the specific embodiment disclosed above and various modifications and changes can be made without departing from the scope of the claims.

### REFERENCE SIGNS LIST

10 Training apparatus
20 Classification apparatus
101 Reading unit
102 Objective function calculation unit
103 Parameter updating unit
104 End condition determination unit
105 Storage unit
201 Classification unit
202 Storage unit

1. A training apparatus comprising:
a processor; and
a memory storing computer-executable instructions configured to execute a method comprising:
receiving a set of first data elements that are labeled and a set of second data elements that are unlabeled as inputs;
calculating a value of a predetermined objective function that represents an evaluation index when a false positive rate is in a predetermined range and a derivative of the predetermined objective function with respect to a parameter; and
updating the parameter such that the value of the predetermined objective function is maximized or minimized using the value of the predetermined objective function and the derivative.

2. The training apparatus according to claim 1, wherein the set of first data elements includes positive-example data elements labeled with a label indicating a positive example and negative-example data elements labeled with a label indicating a negative example,
wherein the evaluation index is a partial area under a receiver operating characteristic curve (AUC), and
wherein the predetermined objective function is represented by a weighted sum of:
a first partial AUC calculated from the positive-example data elements and the negative-example data elements,
a second partial AUC calculated from the positive-example data elements and the second data elements, and
a third partial AUC calculated from the negative-example data elements and the second data elements.

3. The training apparatus according to claim 2, wherein the predetermined objective function includes a classifier that has the parameter and outputs, when a data element to be classified has been input, a score on classification of the data element to be classified as a positive example,
wherein the partial area under a receiver operating characteristic curve (AUC) becomes higher when scores of the positive-example data elements are higher than scores of the negative-example data elements which are in a predetermined range of false positive rates,
wherein the second partial AUC becomes higher when scores of the positive-example data elements are higher than scores of second data elements which are in a predetermined range of false positive rates among the second data elements classified as negative examples by the classifier, and
wherein the third partial AUC becomes higher when scores of the second data elements classified as positive examples by the classifier are higher than scores of the negative-example data elements which are in a predetermined range of false positive rates.

4. The training apparatus according to claim 1, the computer-executable instructions further configured to execute a method comprising:
determining whether or not a predetermined end condition is satisfied,
wherein the training apparatus is configured to repeat the calculating the value of the predetermined objective function and the derivative and the updating of the parameter until the predetermined end condition is satisfied.

5. A computer-implemented method for training, comprising:
receiving a set of first data elements that are labeled and a set of second data elements that are unlabeled as inputs,
calculating a value of a predetermined objective function that represents an evaluation index when a false positive rate is in a predetermined range and a derivative of the predetermined objective function with respect to a parameter; and
updating the parameter such that the value of the predetermined objective function is maximized or minimized using the value of the predetermined objective function and the derivative.

6. A computer-readable non-transitory recording medium storing computer-executable program instructions that when executed by a processor cause a computer system to execute a method comprising:
receiving a set of first data elements that are labeled and a set of second data elements that are unlabeled as inputs;
calculating a value of a predetermined objective function that represents an evaluation index when a false positive rate is in a predetermined range and a derivative of the predetermined objective function with respect to a parameter; and
updating the parameter such that the value of the predetermined objective function is maximized or minimized using the value of the predetermined objective function and the derivative.

7. The training apparatus according to claim 1, wherein a level of accuracy of classifying the second data elements at the false positive rate is higher than classifying the second data elements at another false positive rate.

8. The training apparatus according to claim 2, the computer-executable instructions further configured to execute a method comprising:
determining whether or not a predetermined end condition is satisfied,
wherein the training apparatus is configured to repeat the calculating the value of the predetermined objective function and the derivative and the updating of the parameter until the predetermined end condition is satisfied.

9. The training apparatus according to claim 3, the computer-executable instructions further configured to execute a method comprising:
determining whether or not a predetermined end condition is satisfied; and
repeating the calculating the value of the predetermined objective function and the derivative and the updating of the parameter until the predetermined end condition is satisfied.

10. The computer-implemented method according to claim 5, wherein the set of first data elements includes positive-example data elements labeled with a label indicating a positive example and negative-example data elements labeled with a label indicating a negative example,
wherein the evaluation index is a partial area under a receiver operating characteristic curve (AUC), and
wherein the predetermined objective function is represented by a weighted sum of:
a first partial AUC calculated from the positive-example data elements and the negative-example data elements,
a second partial AUC calculated from the positive-example data elements and the second data elements, and
a third partial AUC calculated from the negative-example data elements and the second data elements.

11. The computer-implemented method according to claim 5, the method further comprising:
determining whether or not a predetermined end condition is satisfied; and
repeating the calculating the value of the predetermined objective function and the derivative and the updating of the parameter until the predetermined end condition is satisfied.

12. The computer-implemented method according to claim 5, wherein a level of accuracy of classifying the second data elements at the false positive rate is higher than classifying the second data elements at another false positive rate.

13. The computer-readable non-transitory recording medium according to claim 6, wherein the set of first data elements includes positive-example data elements labeled with a label indicating a positive example and negative-example data elements labeled with a label indicating a negative example,
wherein the evaluation index is a partial area under a receiver operating characteristic curve (AUC), and
wherein the predetermined objective function is represented by a weighted sum of:
a first partial AUC calculated from the positive-example data elements and the negative-example data elements,
a second partial AUC calculated from the positive-example data elements and the second data elements, and
a third partial AUC calculated from the negative-example data elements and the second data elements.

14. The computer-readable non-transitory recording medium according to claim 6, the computer-executable program instructions when executed further cause the computer system to execute a method comprising:
determining whether or not a predetermined end condition is satisfied; and
repeating the calculating the value of the predetermined objective function and the derivative and the updating of the parameter until the predetermined end condition is satisfied.

15. The computer-readable non-transitory recording medium according to claim 6, wherein a level of accuracy of classifying the second data elements at the false positive rate is higher than classifying the second data elements at another false positive rate.

16. The computer-implemented method according to claim 10, wherein the predetermined objective function includes a classifier that has the parameter and outputs, when a data element to be classified has been input, a score on classification of the data element to be classified as a positive example,
wherein the partial area under a receiver operating characteristic curve (AUC) becomes higher when scores of the positive-example data elements are higher than scores of the negative-example data elements which are in a predetermined range of false positive rates,
wherein the second partial AUC becomes higher when scores of the positive-example data elements are higher than scores of second data elements which are in a predetermined range of false positive rates among the second data elements classified as negative examples by the classifier, and
wherein the third partial AUC becomes higher when scores of the second data elements classified as positive examples by the classifier are higher than scores of the negative-example data elements which are in a predetermined range of false positive rates.

17. The computer-implemented method according to claim 10, the method further comprising:
determining whether or not a predetermined end condition is satisfied; and
repeating the calculating the value of the predetermined objective function and the derivative and the updating of the parameter until the predetermined end condition is satisfied.

18. The computer-readable non-transitory recording medium according to claim 13, wherein the predetermined objective function includes a classifier that has the parameter and outputs, when a data element to be classified has been input, a score on classification of the data element to be classified as a positive example,
wherein the partial area under a receiver operating characteristic curve (AUC) becomes higher when scores of the positive-example data elements are higher than scores of the negative-example data elements which are in a predetermined range of false positive rates,
wherein the second partial AUC becomes higher when scores of the positive-example data elements are higher than scores of second data elements which are in a predetermined range of false positive rates among the second data elements classified as negative examples by the classifier, and
wherein the third partial AUC becomes higher when scores of the second data elements classified as positive examples by the classifier are higher than scores of the negative-example data elements which are in a predetermined range of false positive rates.

19. The computer-readable non-transitory recording medium according to claim 13, the computer-executable program instructions when executed further cause the computer system to execute a method comprising:
determining whether or not a predetermined end condition is satisfied; and
repeating the calculating the value of the predetermined objective function and the derivative and the updating of the parameter until the predetermined end condition is satisfied.

20. The computer-implemented method according to claim 16, the method further comprising:
determining whether or not a predetermined end condition is satisfied; and
repeating the calculating the value of the predetermined objective function and the derivative and the updating of the parameter until the predetermined end condition is satisfied.
